(19) United States
(12) Patent Application Publication
(10) Pub. No.: US 2013/0342065 A1
(43) Pub. Date: Dec. 26, 2013

(54) BRUSHLESS MOTOR AND METHOD FOR MANUFACTURING BRUSHLESS MOTOR

(71) Applicant: ASMO CO., LTD., (US)

(72) Inventors: Rintaro HORIZUMI, Anjo-shi (JP); Takumi SUZUKI, Toyohashi-shi (JP)

(21) Appl. No.: 13/875,102

(22) Filed: May 1, 2013

(30) Foreign Application Priority Data
May 8, 2012 (JP) 2012-106873
Aug. 24, 2012 (JP) 2012-185163

(51) Int. Cl. H02K 1/16; H02K 15/02; H02K 1/27

(52) U.S. Cl. CPC H02K 1/16; H02K 1/2746; H02K 15/024
USPC 310/156.15; 310/216.011; 29/596

(57) ABSTRACT

A brushless motor includes a stator and a rotor. The stator includes an m number of slots spaced apart from one another by a slot angular interval k in a circumferential direction. The rotor includes n magnetic poles. The stator core includes a plurality of core sheets stacked with circumferential positions shifted from one another by a first angle. The first angle is a product of one of a plurality of values of j and the slot angular interval k. The plurality of values of j are values that satisfy (i×n)<(least common multiple of n and m) but do not satisfy (i×n×j×(360/m))=(360×N), where i, j, and N are natural numbers.

### BACKGROUND OF THE INVENTION

The present invention relates to a brushless motor and a method for manufacturing a brushless motor.

In the prior art, a brushless motor having a so-called skew structure includes a plurality of stator cores, which are divided along an axial direction of the brushless motor and which are arranged shifted from one another in a circumferential direction. The brushless motor having the skew structure can reduce cogging torque (for example, refer to Japanese Laid-Open Patent Publication No. 2-254954).

However, the brushless motor described above reduces the cogging torque caused by teeth (slot) of a stator and the number of poles of a rotor but cannot suppress degradation in the cogging torque characteristic caused by the accuracy of the stator core, in particular, the accuracy of each tooth (variation in shape of each tooth during manufacturing).

It is an object of the present invention to provide a brushless motor and a method for manufacturing a brushless motor capable of suppressing degradation in the cogging torque characteristic caused by the accuracy of the stator core.

To achieve the above object, one aspect of the present invention provides a brushless motor including a stator and a rotor. The stator includes a stator core having a plurality of teeth, which extend in a radial direction, and a winding. A slot is formed between adjacent ones of the teeth. The stator includes an m number of the slots spaced apart from one another by a slot angular interval k in a circumferential direction, and the winding is arranged in the slot and wound around the teeth. The rotor includes an n number of magnetic poles. The stator core includes a plurality of core sheets formed by punching a plate material with the same punch die. The stator core includes the core sheets, which are stacked under a situation in which circumferential positions are shifted from one another by a first angle, or a plurality of core sheet groups, which are stacked under a situation in which circumferential positions are shifted from one another by the first angle and with each core sheet group including the core sheets having circumferential positions that are the same. The first angle is a product of one of a plurality of values of j and the slot angular interval k. The plurality of values of j are values that satisfy (i×n)<(least common multiple of n and m) but do not satisfy (i×n×j×(360/m))=(360×N), where i, j, and N are natural numbers.

A further aspect of the present invention is a method for manufacturing a brushless motor. The brushless motor includes a stator and a rotor. The stator includes a stator core having a plurality of teeth, which extend in a radial direction, and a winding. A slot is formed between adjacent ones of the teeth. The stator includes an m number of slots spaced apart by a slot angular interval k in a circumferential direction. The winding is arranged in the slot and wound around the teeth. The rotor includes an n number of magnetic poles. The method includes punching a plate material with the same punch die to form a plurality of core sheets, and forming the stator core by stacking the core sheets, under a situation in which circumferential positions are shifted from one another by a first angle, or stacking a plurality of core sheet groups, under a situation in which circumferential positions are shifted from one another by the first angle and with each core sheet group including the core sheets having circumferential positions that are the same. The first angle is a product of one of a plurality of values of j and the slot angular interval k. The plurality of values of j are values that satisfy (i×n)<(least common multiple of n and m) but do not satisfy (i×n×j×(360/m))=(360×N), where i, j, and N are natural numbers.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a cross-sectional view of a motor according to a first embodiment of the present invention;

FIG. 2A is a partial cross-sectional view of a stator and a rotor in the motor of FIG. 1;

FIG. 2B is a cross-sectional view taken along line 2B-2B in FIG. 2A;

FIGS. 3A and 3B are plan views each illustrating a manufacturing method of the brushless motor (stator core) of FIG. 1;

FIG. 4 is a plan view of the rotor of FIG. 2A;

FIG. 5 is a perspective view of the rotor of FIG. 4;

FIG. 6 is a perspective view of the rotor core of FIG. 4;

FIG. 7 is a plan view of the rotor core of FIG. 4;

FIGS. 8A and 8B are developed views illustrating fixed positions of first to fifth permanent magnets in the motor of FIG. 4;

FIG. 9 is a characteristic chart showing the relationship of the angle of the rotor and the cogging torque in the motor of FIG. 1;

FIGS. 10A and 10B are plan views each illustrating a manufacturing method of the brushless motor (stator core) according to another example;

FIG. 11 is a cross-sectional view taken along an axial direction of a brushless motor according to a second embodiment of the present invention;

FIG. 12A is a cross-sectional view in a direction orthogonal to the axial direction of the brushless motor of FIG. 11;

FIG. 12B is a cross-sectional view taken along line 12B-12B in FIG. 12A;

FIG. 13 is an enlarged cross-sectional view of a stator of FIG. 12A;

FIG. 14 is a side view of the stator core of FIG. 12A;

FIGS. 15A and 15B are plan views each illustrating a manufacturing method of the brushless motor (stator core) of FIG. 11;

FIGS. 16A and 16B are enlarged cross-sectional views of a stator in a further example; and

FIGS. 17A and 17B are plan views each illustrating a manufacturing method of the brushless motor (stator core) in another example.

### DETAILED DESCRIPTION OF THE PREFERRED EMBODIMENTS

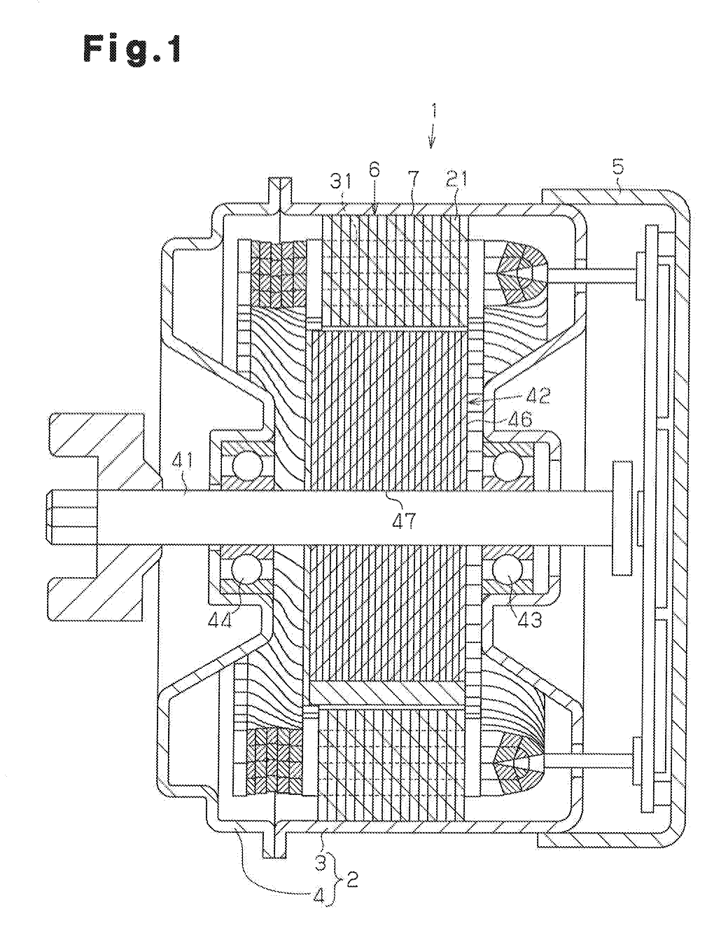

One embodiment of an inner rotor type brushless motor according to the present invention will now be described with reference to FIGS. 1 to 9.

As shown in FIG. 1, a case 2 serving as a fixing member of a brushless motor 1 includes a tubular housing 3 having a closed end, and a front end plate 4 that closes the open front end (left side in FIG. 1) of the tubular housing 3. A circuit accommodation box 5 accommodating a power supply circuit such as a circuit substrate and the like is attached to a rear end (right side in FIG. 1) of the tubular housing 3.

A stator 6 is fixed to an inner circumferential surface of the tubular housing 3. The stator 6 includes a stator core 7.

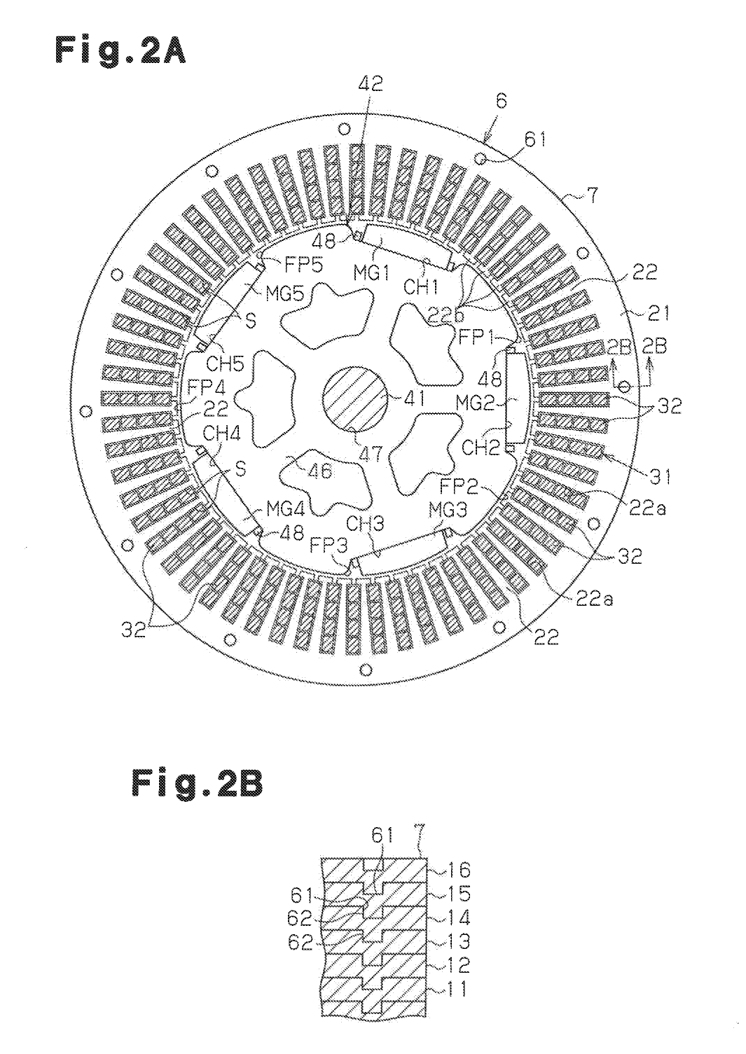

As shown in FIGS. 2A and 2B, the stator core 7 includes a plurality of core sheets 11 to 16 stacked in an axial direction. Each of the core sheets 11 to 16 is formed from an electromagnetic steel plate serving as a plate material. The stator core 7 includes an annular portion 21 and an m number of teeth 22 arranged along a circumferential direction of the annular portion 21. Each tooth 22 extends radially inward from the annular portion 21. In the first embodiment, m is 60 (m=60), that is, sixty teeth 20 are formed. Therefore, the number m of slots S formed between the teeth 22 is also sixty. The teeth 22 of the first embodiment each includes a width reducing portion 22a around which a segment winding 31, which will be described later, is wound. The width reducing portion 22a has a width in the circumferential direction that becomes narrower toward the radially inner side. A rotor opposing portion 22b having a shape that slightly projects toward opposite sides in the circumferential direction is formed on the radially inner side of the width reducing portion 22a of each tooth 22. As shown in FIG. 1, the stator core 7 is held by the case 2 by pressing the annular portion 21 connecting the radially outward ends of the teeth 22 against the inner circumferential surface of the case 2 (specifically, tubular housing 3).

As shown in FIGS. 1 and 2A, a plurality of segment windings 31 serving as a plurality of windings are wound around the teeth 22 of the stator core 7. Specifically, the segment windings 31 are windings in a three phase (U phase, V phase, W phase) Y-connection. Each of the segment windings 31 includes a plurality of segment conductors 32 electrically connected to on another. Each segment conductor 32 is formed by a substantially U-shapes wire having a uniform cross-sectional shape. Each segment conductor 32 includes two linear portions and a coupling portion connecting the linear portions. The two linear portions extend through two slots S, which are located at different circumferential positions and are arranged at different radial positions (inner side and outer side) in the two slots S. In the first embodiment, the linear portions of four segment conductors 32 are arranged along the radial direction in each slot S. The segment winding 31 is formed mainly from the substantially U-shaped segment conductor 32. However, for example, a special type of segment conductor (e.g., with only one linear portion) is used for winding ends (power supply connection terminal, neutral point connection terminal, etc.).

The stator 6 generates a rotating magnetic field by controlling the current supplied to the segment winding 31. The rotating magnetic field rotates a rotor 42, which is fixed to a rotation shaft 41 arranged at the inner side of the stator 6, in a forward direction (clockwise direction in FIG. 2A) and a reverse direction (counterclockwise direction in FIG. 2) by such.

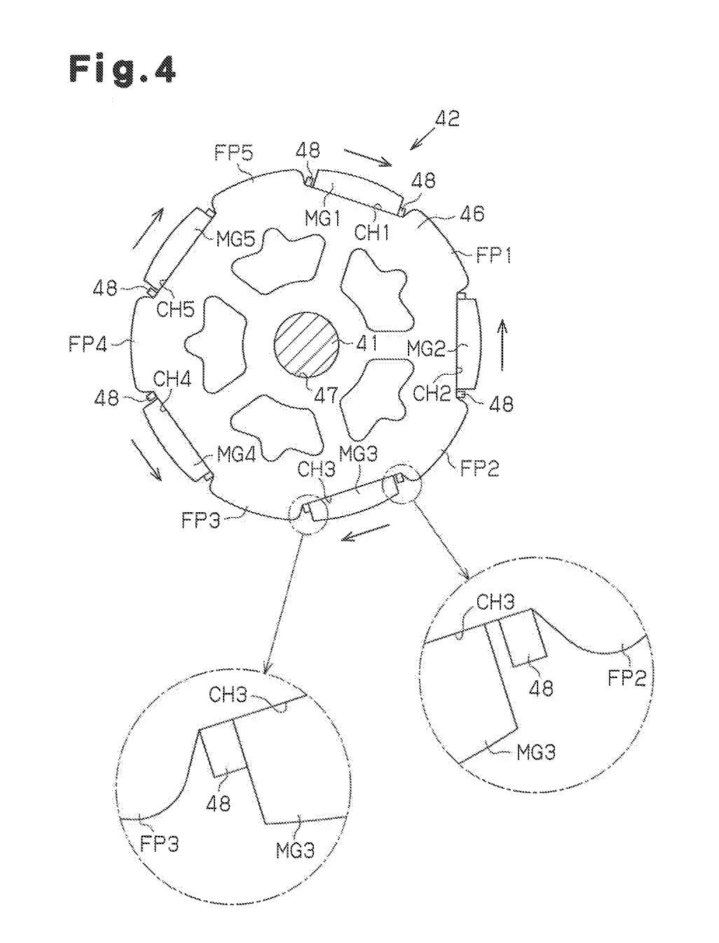

As shown in FIGS. 2A and 4, the rotor 42 is a rotor having a consequent pole type structure. The rotor 42 is externally fitted and fixed to the rotation shaft 41. As shown in FIG. 1, the rotation shaft 41 is rotatably supported by two bearings 43 and 44, which are arranged in the case 2.

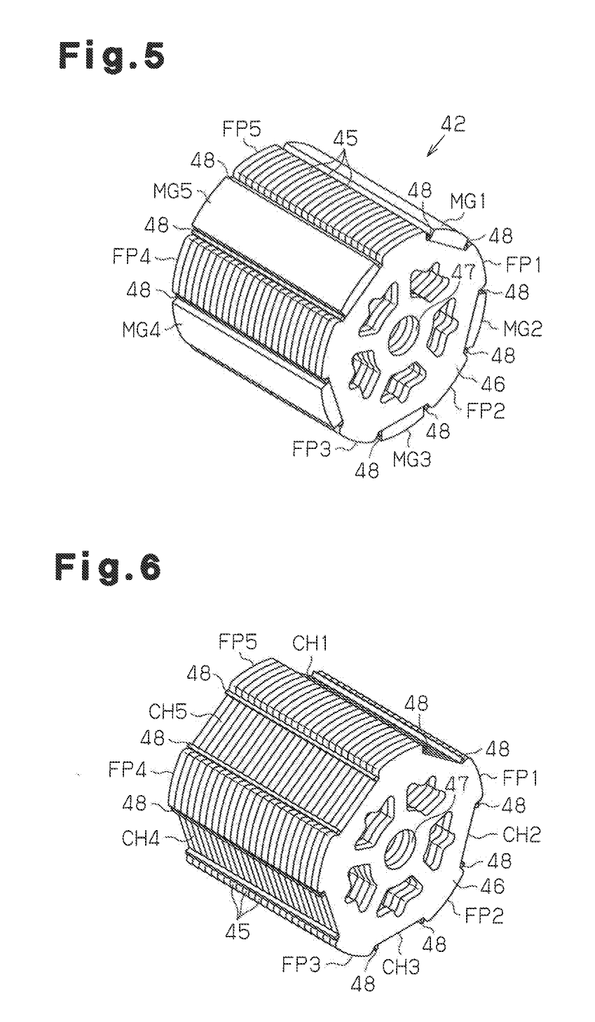

As shown in FIGS. 5 and 6, the rotor 42 includes a rotor core 46 having a plurality of stacked rotor core sheets 45. The rotor core 46 is cylindrical. A through-hole 47 into which the rotation shaft 41 is press-fitted extends in the axial direction through the center portion of the rotor core 46. The rotor core 46 includes five recesses serving as setting portions arranged at equal angular intervals along the circumferential direction. Hereinafter, the five recesses are referred to as first to fifth recesses CH1 to CH5 in order in the clockwise direction (forward rotation direction) of FIGS. 2 and 4. Each of the recesses CH1 to CH5 is arranged in a recessed manner over the entire axial direction.

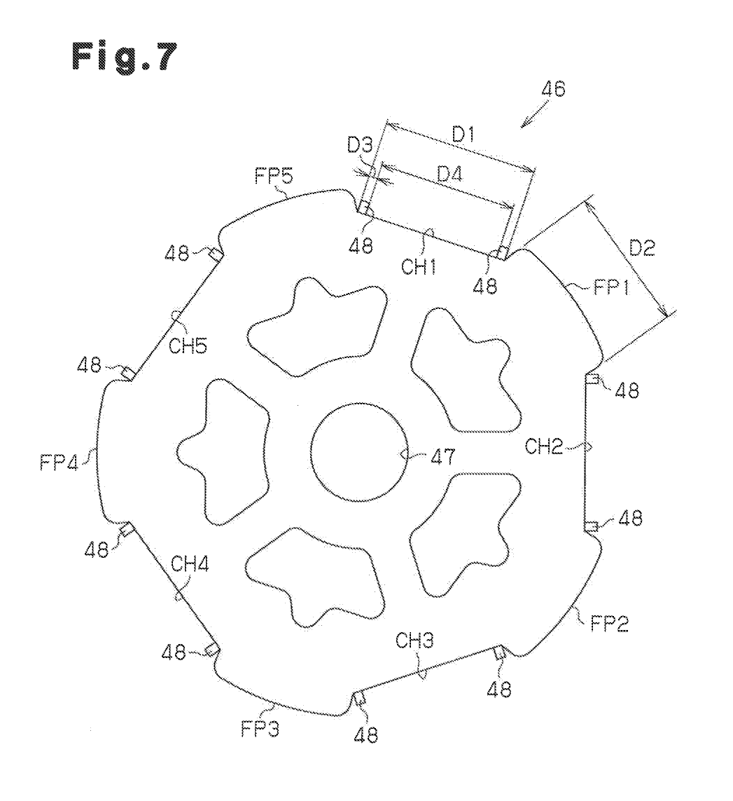

As shown in FIG. 7, the circumferential widths of the first to fifth recesses CH1 to CH5, that is, the widths D1 of the bottom surface are all the same. Each bottom surface of the first to fifth recesses CH1 to CH5 is a flat plane extending in a direction orthogonal to a line extending in the radial direction from the center axis of the rotation shaft 41 and through the center in the width direction of the bottom surface.

The rotor core 46 includes five pseudo-magnetic poles (hereinafter first to fifth pseudo-magnetic poles FP1 to FP5). The pseudo-magnetic poles FP1 to FP5 are each located between two adjacent ones of the first to fifth recesses CH1 to CH5 in the circumferential direction.

The first pseudo-magnetic pole FP1 is formed between the first recess CH1 and the second recess CH2, and the second pseudo-magnetic pole FP2 is formed between the second recess CH2 and the third recess CH3. The third pseudo-magnetic pole FP3 is formed between the third recess CH3 and the fourth recess CH4, and the fourth pseudo-magnetic pole FP4 is formed between the fourth recess CH4 and the fifth recess CH5. Further, the fifth pseudo-magnetic pole FP5 is formed between the fifth recess CH5 and the first recess CH1.

As shown in FIG. 7, circumferential widths D2 of the first to fifth pseudo-magnetic poles FP1 to FP5 are all the same. The width D2 is smaller than the circumferential width D1 of the first to fifth recesses CH1 to CH5.

A positioning member 48 serving as a lock portion is fixed to each of two ends in the width direction in each bottom surface of the first to fifth recesses CH1 to CH5. Each positioning member 48 extends along the axial direction of the rotor 42. Each positioning member 48 is a square material having a square cross-sectional shape, and includes two side surfaces and a bottom surface. The corner formed by one side surface and the bottom surface contacts the corner formed by the side surface of the first to fifth pseudo-magnetic poles FP1 to FP5 and the bottom surface of the first to fifth recesses CH1 to CH5.

Circumferential widths D3 of the positioning members 48 are all the same. The width D3 of each positioning member 48 is set such that an interval D4 between the opposing inner side surfaces of the two opposing positioning members 48 is greater than the circumferential width D2 of the first to fifth pseudo-magnetic poles FP1 to FP5.

As shown in FIG. 4, first to fifth permanent magnets MG1 to MG5 are fixed to the bottom surfaces of the first to fifth recesses CH1 to CH5 where the positioning members 48 are fixed.

Specifically, the first permanent magnet MG1 is fixed to the first recess CH1, and the second permanent magnet MG2 is fixed to the second recess CH2. The third permanent magnet MG3 is fixed to the third recess CH3, and the fourth permanent magnet MG4 is fixed to the fourth recess CH4. Further, the fifth permanent magnet MG5 is fixed to the fifth recess CH5.

The bottom surfaces of the first to fifth permanent magnets MG1 to MG5 have a planar shape in conformance with the bottom surfaces of the first to fifth recesses CH1 to CH5. The two side surfaces in the width direction (direction along the circumferential direction) of each of the first to fifth permanent magnets MG1 to MG5 extend so as to be orthogonal to the bottom surfaces of the first to fifth permanent magnets MG1 to MG5. The length between the side surfaces of the first to fifth permanent magnets MG1 to MG5 is the same as the circumferential width D2 of the first to fifth pseudo-magnetic poles FP1 to FP5.

The first to fifth permanent magnets MG1 to MG5 are fixed to the corresponding first to fifth recesses CH1 to CH5 so that the magnetic pole of the surface at the radially outer side of each of the first to fifth permanent magnets MG1 to MG5 is an S pole and the magnetic pole of the surface at the radially inner side is an N pole. Accordingly, the outer side surfaces (surface on the stator 6 side) of the first to fifth pseudo-magnetic poles FP1 to FP5 function as the N poles. As a result, the rotor 42 has the N pole and the S pole alternately arranged in the circumferential direction, and the number n of magnetic poles is ten (n=10).

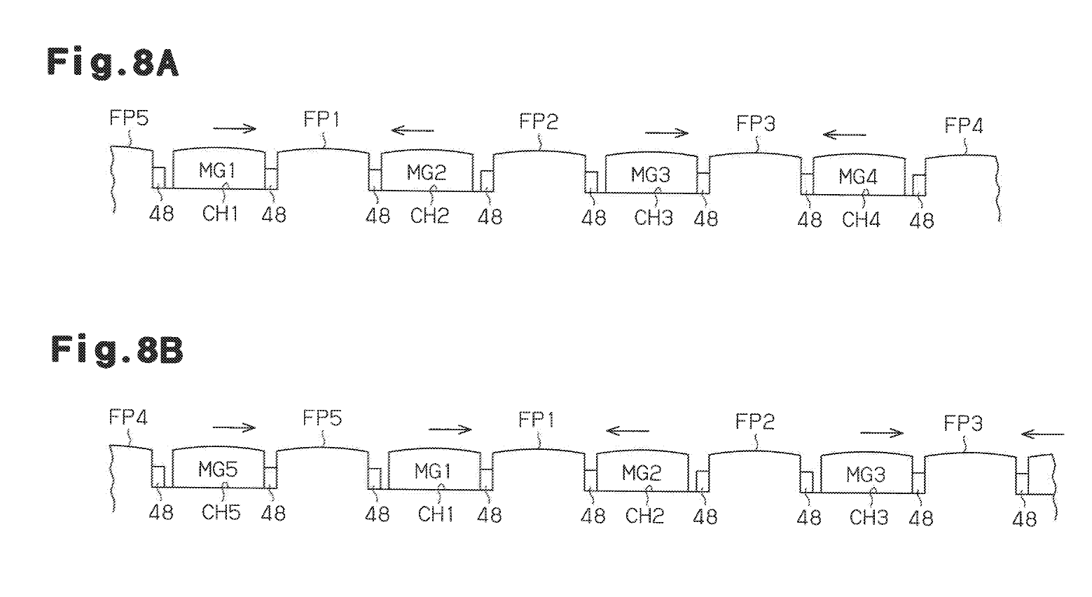

The fixing method and the fixing position of the first to fifth permanent magnets MG1 to MG5 corresponding to the first to fifth recesses CH1 to CH5 will now be described with reference to FIGS. 4, 8A, and 8B.

The first permanent magnet MG1 is fixed to the bottom surface of the first recess CH1 in contact with the positioning member 48 fixed to the right side end of the first recess CH1 in FIG. 8. Thus, the first permanent magnet MG1 is fixed using the positioning member 48 at the right side of the first recess CH1 as a reference, that is, using the positioning member 48 at the forward side in the clockwise direction (forward rotation direction) of the first recess CH1 in FIG. 4 as a reference.

Next, the second permanent magnet MG2 is fixed to the bottom surface of the second recess CH2 in contact with the positioning member 48 fixed to the left side end of the second recess CH2 in FIG. 8. Thus, the second permanent magnet MG2 is fixed using the positioning member 48 at the left side of the second recess CH2 as a reference, that is, using the positioning member 48 at the forward side in the counterclockwise direction (reverse rotation direction) of the second recess CH2 in FIG. 4 as a reference.

The third permanent magnet MG3 is then fixed to the bottom surface of the third recess CH3 in contact with the positioning member 48 fixed to the right side end of the third recess CH3 in FIG. 8. Thus, the third permanent magnet MG3 is fixed using the positioning member 48 at the right side of the third recess CH3 as a reference, that is, using the positioning member 48 at the forward side in the clockwise direction (forward rotation direction) of the third recess CH3 in FIG. 4 as a reference.

The fourth permanent magnet MG4 is then fixed to the bottom surface of the fourth recess CH4 in contact with the positioning member 48 fixed to the left side end of the fourth recess CH4 in FIG. 8. Thus, the fourth permanent magnet MG4 is fixed using the positioning member 48 at the left side of the fourth recess CH4 as a reference, that is, using the positioning member 48 at the forward side in the counterclockwise direction (reverse rotation direction) of the fourth recess CH4 in FIG. 4 as a reference.

The fifth permanent magnet MG5 is then fixed to the bottom surface of the fifth recess CH5 in contact with the positioning member 48 fixed to the right side end of the fifth recess CH5 in FIG. 8. Thus, the fifth permanent magnet MG5 is fixed using the positioning member 48 at the right side of the fifth recess CH5 as a reference, that is, using the positioning member 48 at the forward side in the clockwise direction (forward rotation direction) of the fifth recess CH5 in FIG. 4 as a reference.

Accordingly, the first, third, and fifth permanent magnets MG1, MG3, and MG5 included in a first group are fixed to the bottom surfaces using the positioning members 48 at the forward side (right side in FIG. 8) relative to the forward rotation direction of the first, third, and fifth recesses CH1, CH3, CH5 as references and located closer to these positioning members 48. In contrast, the second and fourth permanent magnets MG2 and MG4 included in a second group are fixed to the bottom surfaces using the positioning members 48 at the forward side (left side in FIG. 8) in the reverse rotation direction of the second and fourth recesses CH2 and CH4 as references and located closer to these positioning members 48.

In other words, the direction in which the first permanent magnet MG1, the third permanent magnet MG3, and the fifth permanent magnet MG5 are arranged toward differs from the direction in which the second permanent magnet MG2 and the fourth permanent magnet MG4 are arranged toward.

The structure of the stator core 7 in the brushless motor 1 of the first embodiment and the method for manufacturing the stator core 7 will now be described.

The core sheets 11 to 16 are punched out from an electromagnetic steel plate serving as a plate material with the same punch die (not shown). In a rotation stacking step, each of the punched out core sheets 11 to 16 are rotated in the circumferential direction by a first angle and stacked shifted by the first angle relative to one another. The first angle is a product of one of a plurality of values of j and an angular interval k (i.e., 360°/m) of the slots S.

The plurality of values of j are values that satisfy

(i×n)<(least common multiple of n and m), but do not satisfy

(i×n×j×(360/m))=(360×N).

The reference symbols i, j, and N are natural numbers.

Specifically, in the first embodiment, the number m of the slots S is 60 (m=60) and the number n of magnetic poles is 10 (n=10). Thus,

(i×10)<60 is satisfied. This satisfies

(i×n)<(least common multiple of n and m).

Therefore, i<6 is satisfied, and the solutions of i are 1, 2, 3, 4, and 5 (i.e., integer number from 1 to 5).

The value of j that does not satisfy (i×10×j×(360/60))=(360×N) is obtained under the condition that (i×n×j×(360/m))=(360×N) is not satisfied.

That is, the value of j that does not satisfy j=(6×N)/i is obtained. This obtains the value of j that does not satisfy j=6N, does not satisfy j=3N, does not satisfy j=2N, does not satisfy j=1.5N, and does not satisfy j=1.2N is obtained. The reference symbols i, j, and N are natural numbers.

The solutions of j are thus 1, 5, 7, 11, 13, and so on.

In the first embodiment, “5”, which is one of the solutions of j, is used, and “30°”, which is the angle of the product of “5” and k (360°/m=“6°” in the first embodiment), which is the angular interval of the slots S, is used as the first angle. In other words, in the rotation stacking step, the core sheets 11 to 16 are rotated in the circumferential direction by 30° , and are stacked while being shifted by 30° relative to each other to form the stator core 7.

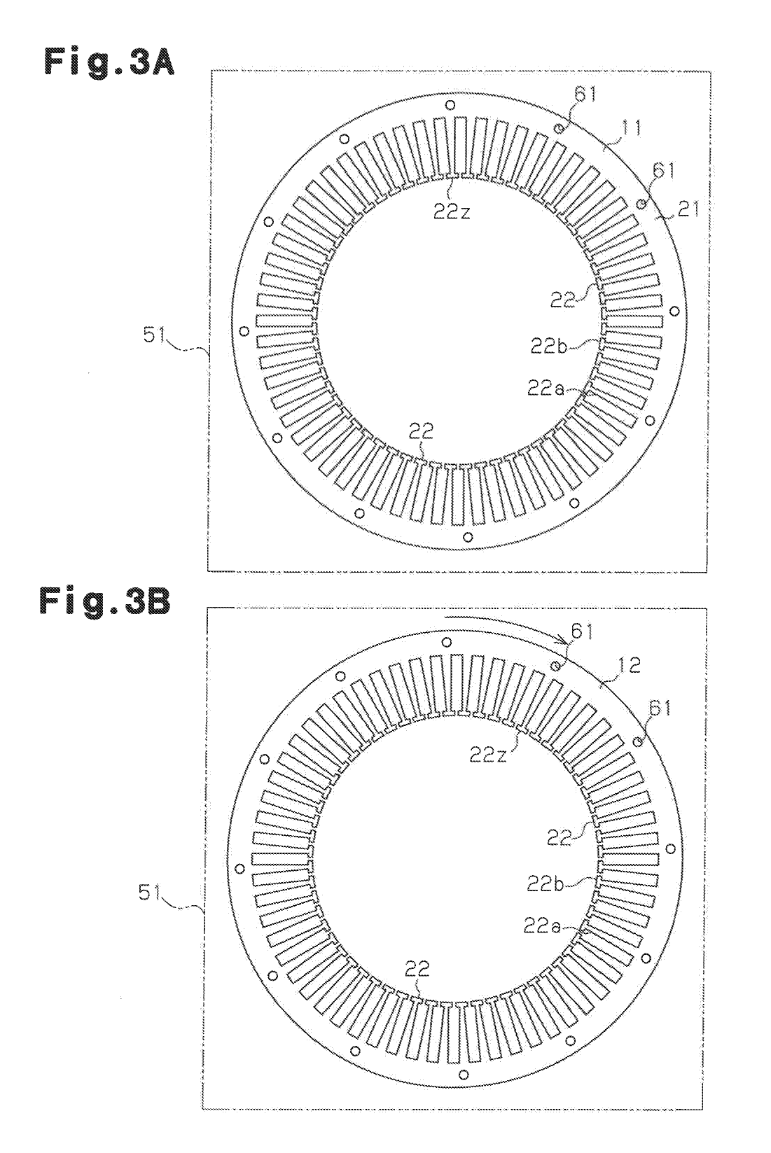

Specifically, as shown in FIG. 3A, the core sheet 11 punched out from the plate material with the punch die (not shown) is first arranged on a stacking device 51 that performs the rotation stacking step. In this case, among the sixty teeth 22, a tooth 22z that is punched out at a specific portion of the punch die is arranged at a specific position of (in FIG. 3A, position immediately above) the stacking device 51.

As shown in FIG. 3B, the core sheet 12 punched out with the same punch die as that used to punch out the core sheet 11 is then arranged on the stacking device 51. The core sheet 12 is arranged on the core sheet 11 arranged in the preceding process. In this case, among the sixth teeth 22, the tooth 22z punched out at a specific portion of the punch die is arranged at a position rotated by 30° in the circumferential direction (clockwise direction as viewed in the drawing) from the specific position of (in FIG. 3B, position immediately above) the stacking device 51.

The core sheet 13 punched out with the same punch die as that used to punch out the core sheets 11 and 12 is then arranged (not shown) on the stacking device 51. The core sheet 13 is arranged on the core sheet 12 arranged in the previous process. In this case, among the sixty teeth 22, the tooth 22z punched out at a specific portion of the punch die is arranged at a position rotated by 30° from the core sheet 12 arranged in the previous process, that is, 60° in the circumferential direction (clockwise direction as viewed in the drawing) from the specific position of (in FIG. 3A, position immediately above) the stacking device 51.

The core sheet 14 punched out with the same punch die as that used to punch out the core sheets 11, 12, and 13 is then arranged (not shown) on the stacking device 51. The core sheet 14 is arranged on the core sheet 13 arranged in the previous process. In this case, among the sixty teeth 22, the tooth 22z punched out at a specific portion of the punch die is arranged at a position rotated by 30° from the core sheet 13 arranged in the previous process, that is, 90° in the circumferential direction (clockwise direction as viewed in the drawing) from the specific position (position immediately above in FIG. 3A) of the stacking device 51.

This is repeated in the same manner to form the stator core 7 in which the core sheets 11 to 16 are stacked in the axial direction.

The stator core 7 of the first embodiment includes p core sheets 11 to 16, where p is a number that is a multiple of a value obtained by dividing the least common multiple of (n×k) and 360 by (n×k).

Specifically, in the first embodiment, the number n of the magnetic poles is 10 (n=10), and k (i.e., 360°/m), which is the angular interval of the slots S, is 6° (k=6). Thus, 24 core sheets 11 to 16 are stacked to form the stator core 7, where 24 is the multiples of a value (i.e., 6) obtained by dividing the least common multiple (i.e., 360) of (10×6) and 360 by (10×6).

As shown in FIG. 2B, the annular portion 21 in the core sheets 11 to 16 of the first embodiment includes press-fitting recesses 61 and press-fitting projections 62, which serve as fixing portions arranged at equal angular intervals along the circumferential direction of the stator 6. The press-fitting recesses 61 and the press-fitting projections 62 fix the stacked core sheets 11 to 16 to one another. The fixing portions (press-fitting recess 61 and press-fitting projection 62) of the first embodiment are each arranged at a position corresponding to the central position in the circumferential direction of a tooth 22 in the annular portion 21. The press-fitting recesses 61 are formed on the upper surface (upper surface in FIG. 2B) of the core sheets 11 to 16, and the press-fitting projections 62 are formed on the lower surface (lower surface in FIG. 2B) of the core sheets 11 to 16 at the same positions in the circumferential direction as the press-fitting recesses 61. The core sheets 11 to 16 stacked on the stacking device 51 are fixed to one another in the vertical direction by press fitting (pressing) the press-fitting projection 62 of the upper core sheet into the press-fitting recess 61 of the lower core sheet. The fixing portions (press-fitting recesses 61 and press-fitting projections 62) are arranged at an angular interval of a common factor of 30°, which is the angle at which the core sheets 11 to 16 are rotated (relative to the lower one of the core sheets 11 to 16) in the rotation stacking step, and 360°. The number of press-fitting recesses 61 and press-fitting projections 62 is less than m (=60), which is the number of the teeth 22 and the slots S. Specifically, in the first embodiment, the annular portion 21 in the core sheets 11 to 16 includes twelve fixing portions (press-fitting recesses 61 and press-fitting projections 62) arranged at an interval of 30°, which is the angular interval of the greatest common factor of 30°, which is the angle at which the core sheets 11 to 16 are rotated, that is, the angle at which the upper core sheet is rotated relative to the lower core sheet 11 to 16, and 360°.

The operation of the brushless motor 1 will now be described.

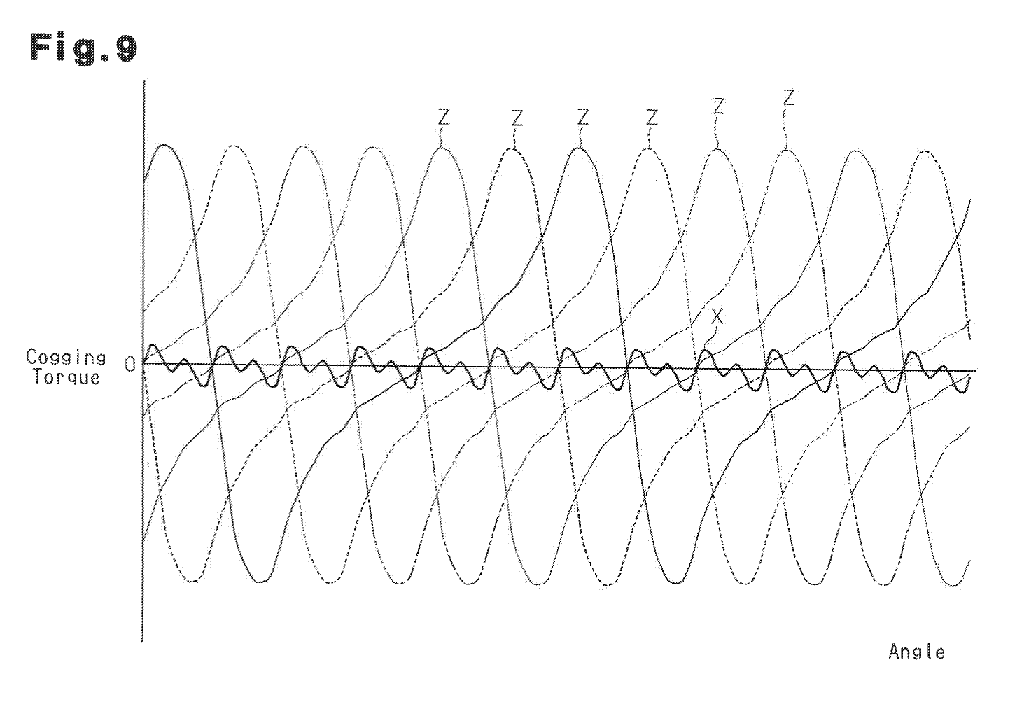

When drive current is supplied from the power supply circuit in the circuit accommodation box 5 to the segment winding 31, the stator 6 generates a rotating magnetic field to rotate the rotor 42 in a forward direction or a reverse direction. The rotor 42 is then rotated and driven while the magnetic flux is exchanged between the teeth 22 and the rotor 42. The cogging torque having the characteristic X shown in FIG. 9 is thus generated by the change in the flow of the magnetic flux that occurs when each of the magnetic poles (first to fifth permanent magnets MG1 to MG5, which are magnet magnetic poles, and the first to fifth pseudo-magnetic poles FP1 to FP5) traverses the vicinity of the distal end (rotor opposing portion 22b) of a tooth 22.

The first embodiment has the advantages described below.

(1) The core sheets 11 to 16, which are punched out with the same punch die, are rotated in the circumferential direction by the above-described angle (30° in the present embodiment) when stacked. This cancels degradation in the cogging torque characteristic caused by the accuracy of the core sheets 11 to 16 of the stator core 7 (in particular, accuracy for the rotor opposing portion 22 at the distal end of each tooth 22) and reduces the cogging torque in a satisfactory manner. When the core sheets 11 to 16 are stacked without being rotated, the cogging torque characteristic may degrade, in particular, due to the variations between the teeth 22 of the core sheets 11 to 16. In the first embodiment, the cogging torque characteristic Z for a single sheet is shifted in the circumferential direction as shown in FIG. 9 so that portions having large amplitudes in the cogging torque cancel one another and thereby obtains a satisfactory characteristic X for the entire cogging torque.

(2) The stator core 7 includes a p number of the core sheets 11 to 16. The value of p is the multiple (24 in the present embodiment) of the value (6 in the present embodiment) obtained by dividing the least common multiple of (n×k) and 360 by (n×k). Thus, degradation in the cogging torque characteristic caused by the accuracy of the core sheets 11 to 16 of the stator core 7 is canceled in a balanced manner. This reduces the cogging torque in a satisfactory manner. In other words, local degradation of the cogging torque characteristic is avoided.

(3) The annular portion 21 of the core sheets 11 to 16 includes the fixing portions (press-fitting recesses 61 and press-fitting projections 62), the number of which is less than m (=60), which is the number of the teeth 22 and the slots S. The fixing portions are arranged at angular intervals of a common factor of 30°, which is an angle by which the core sheets 11 to 16 are rotated, and 360°. Thus, the number of fixing portions is decreased compared to the stator core formed with m fixing portions. Therefore, for example, an appropriate holding force is obtained while enabling the rotation stacking step without increasing to more than necessary the number of fixing portions (press-fitting recesses 61 and press-fitting projections 62) for fixing the stacked core sheets 11 to 16. In the first embodiment, twelve fixing portions (press-fitting recesses 61 and press-fitting projections 62) are formed at intervals of 30° that is the angular interval of the greatest common factor of 30°, which is the angle at which the core sheets 11 to 16 are rotated (relative to the lower core sheets 11 to 16), and 360°. This minimizes the number of fixing portions. The characteristic X of the cogging torque is obtained even if the rotation angle of the core sheets 11 to 16 in the rotation stacking step is 6°, 42°, 66°, 78°, and so on. In such cases, the fixing portions (press-fitting recesses 61 and press-fitting projections 62) needs to be formed every 6°. In contrast, the present embodiment forms a fixing portion for every 30°. This reduces the number of fixing portions.

(4) The fixing portions (press-fitting recesses 61 and press-fitting projections 62) are each formed at a position corresponding to the central position in the circumferential direction of a tooth 22, which is the position where the rigidity is the strongest in the annular portion 21. This suppresses, for example, bending of the core sheets 11 to 16 when forming the fixing portions and the like.

(5) The stator core 7 is held by the case 2 when the annular portion 21 connecting the radially outward ends of the teeth 22 is pressed against the inner circumferential surface of the case 2 (specifically, tubular housing 3). This reduces degradation of the cogging torque characteristic caused by the accuracy of the outer circumference (of the annular portion 21) of the core sheets 11 to 16 of the stator core 7 as compared to a structure in which the annular portion is not pressed.

(6) The winding is the segment winding 31, and four segment conductors 32 (linear portions thereof) are arranged along the radial direction in each slot S. Thus, the tooth 22 has a radial length that is significantly longer than the circumferential width. Although the degradation of the cogging torque characteristic caused by the accuracy of the core sheets 11 to 16 of the stator core 7 (particularly accuracy of the tooth 22) tends to become more significant in such a structure, degradation of the cogging torque characteristic is reduced in a satisfactory manner.

(7) The width reducing portion 22a, which is the portion around which the segment winding 31 is wound, of each tooth 22 has a circumferential width that becomes narrower toward the rotor 42. Such a structure has a stronger tendency of degrading the cogging torque characteristic caused by the accuracy of the core sheets 11 to 16 of the stator core 7 (particularly accuracy of the tooth 22). However, such degradation is reduced in a satisfactory manner.

(8) A plurality of permanent magnets are divided into two groups, that is, a first group including first, third, and fifth permanent magnets MG1, MG3, MG5, and a second group including second and fourth permanent magnets MG2, MG4. The first, third, and fifth permanent magnets MG1, MG3, MG5 included in the first group are fixed at positions closer to the distal end in the forward rotation direction relative to the first, third, and fifth recesses CH1, CH3, CH5, and the second and fourth permanent magnets MG2, MG4 included in the second group are fixed at positions closer to the distal end in the reverse rotation direction relative to the second and fourth recesses CH2, CH4. This reduces changes in the phase of the cogging torque caused by the permanent magnet during rotation.

In other words, if all the permanent magnets are fixed at positions closer to the distal end in the forward rotation direction or the positions closer to the distal end in the reverse rotation direction, the magnetic balance at the pseudo-magnetic pole worsens and the cogging torque is degraded. In particular, for example, the phase of the cogging torque in each permanent magnet greatly changes between when the brushless motor is rotating in the forward direction and when the brushless motor is rotating in the reverse direction.

In contrast, in the present embodiment, the positions where the permanent magnets are to be fixed are allocated to the positions closer to the distal end in the forward direction and the positions closer to the distal end in the reverse rotation direction so that the difference in the number of permanent magnets fixed at the positions closer to the distal end in the forward rotation direction and the number of permanent magnets fixed at the positions closer to the distal end in the reverse rotation direction is one. This reduces the degree of magnetic unbalance at the pseudo-magnetic pole and reduces degradation of the cogging torque. In particular, the change in the phase of the cogging torque that occurs from the permanent magnet is reduced during forward rotation and reverse rotation of the brushless motor 1.

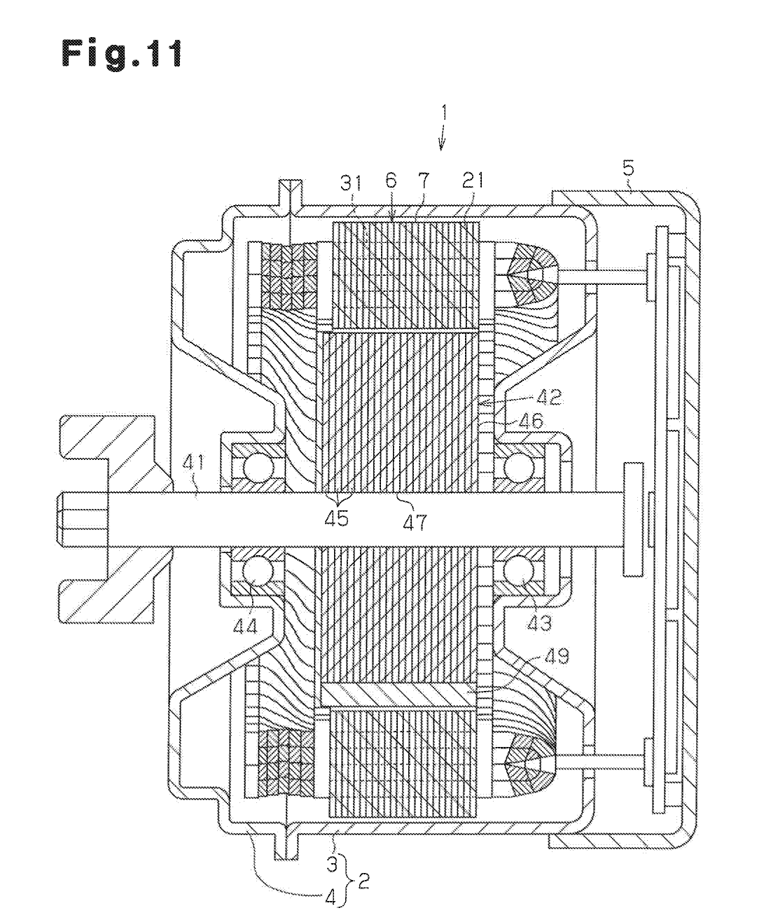

An inner rotor type brushless motor according to a second embodiment of the present invention will now be described with reference to FIGS. 11 to 15B. The main structure of the brushless motor in the second embodiment is the same as the brushless motor of the first embodiment. Thus, in the second embodiment, components differing from the first embodiment will be described in detail. Same reference numerals are given to those components that are the same as the corresponding components of the first embodiment. Such components will not be described in detail.

In the second embodiment, the first to fifth permanent magnets MG1 to MG5 in the first embodiment are each referred to as a permanent magnet 49. In the second embodiment, the first to fifth recesses CH1 to CH5 serving as setting portions in the first embodiment are each referred to as a recess 78, and the first to fifth pseudo-magnetic poles FP1 to FP5 in the first embodiment are each referred to as a salient pole 79 serving as a pseudo-magnetic pole.

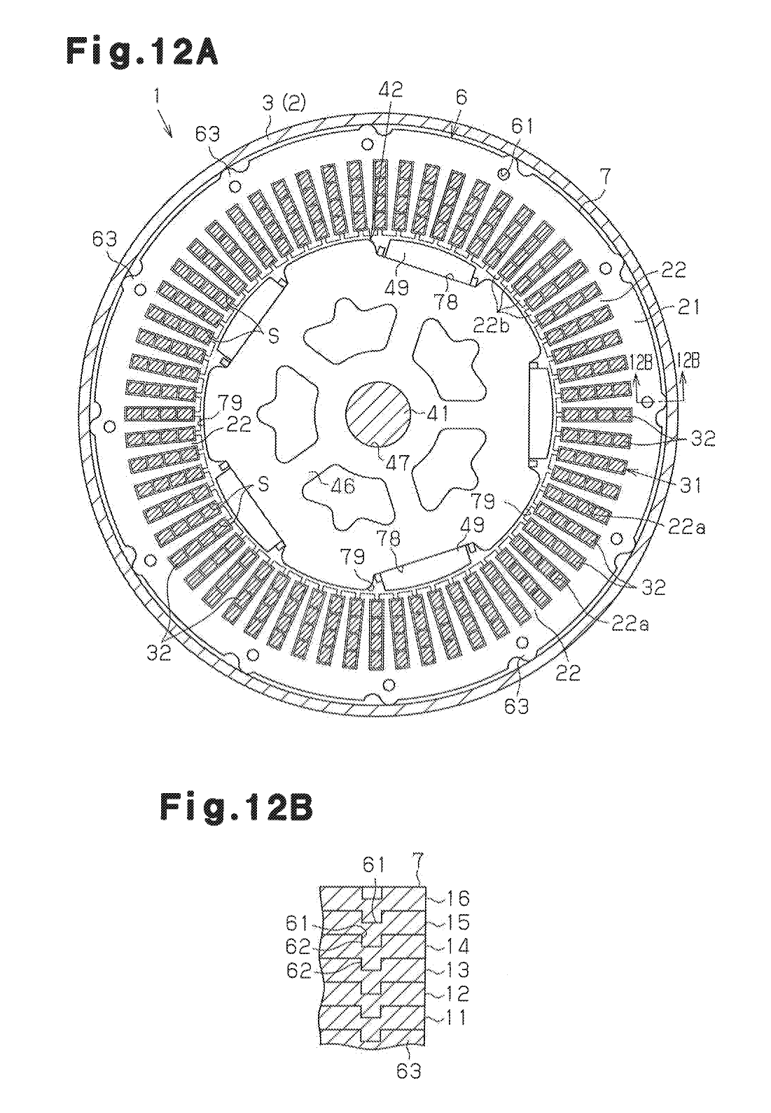

As shown in FIG. 12A, the permanent magnet 49 is fixed in each fixing recess 78 with a gap in the circumferential direction from the salient poles 79. Each permanent magnet 49 is arranged relative to the rotor core 46 so that the magnetic pole at the surface on the radially inner side of the permanent magnet 49 is the S pole and the magnetic pole at the surface on the radially outer side (stator 6 side) is the N pole. Thus, the outer side surface (surface on the stator 6 side) of the salient pole 79 adjacent in the circumferential direction relative to the permanent magnet 49 is the S pole, which is a magnetic pole that differs from the outer side surface of the permanent magnet 49. As a result, the rotor 42 has N poles and S poles alternately arranged in the circumferential direction. The number n of the magnetic poles is ten (n=10).

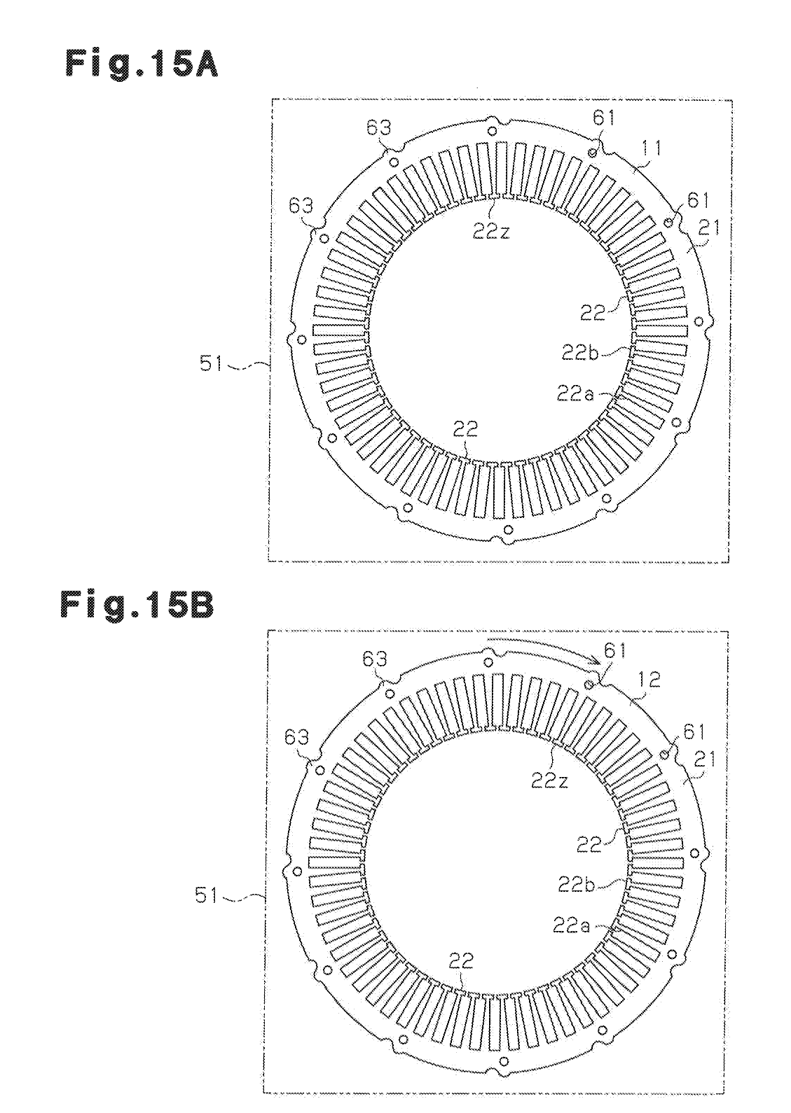

In the same manner as the first embodiment, the stator core 7 in the brushless motor 1 of the second embodiment includes the core sheets 11 to 16 that are rotated in the circumferential direction by a first angle when stacked to be shifted by the first angle (30°) relative to each other. In other words, the stator core 7 of the second embodiment is formed by the manufacturing method including the rotation stacking step in the same manner as the first embodiment. FIGS. 15A and 15B respectively correspond to FIGS. 3A and 3B of the first embodiment.

Further, as shown in FIG. 12A, in the second embodiment, a plurality of shape changing portions 63 for reducing the contact area of the outer circumferential surfaces of the core sheets 11 to 16 and the inner circumferential surface of the tubular housing 3 are spaced apart by intervals in the circumferential direction on the outer circumferential surfaces of the core sheets 11 to 16.

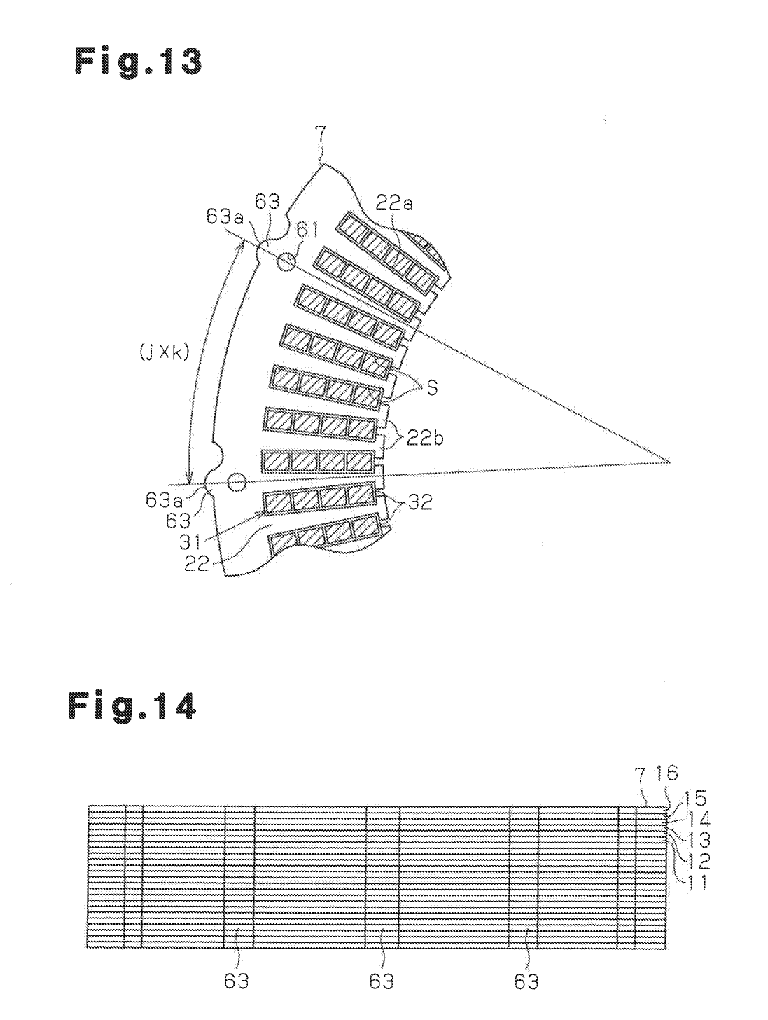

Specifically, as shown in FIG. 13, the shape changing portions 63 are formed at an angular interval of a common factor of 30°, which is an angle (j×k) at which the core sheets 11 to 16 are rotated, and 360°. In the second embodiment, twelve shape changing portions 63 are formed on the core sheets 11 to 16 at intervals of 30° that is an angular interval of a greatest common factor of 30°, which is an angle at which the core sheets 11 to 16 are rotated relative to the lower core sheets 11 to 16, and 360°. In other words, twelve shape changing portions 63 are arranged such that the positional relationship of each shape changing portion 63 and the corresponding tooth 22 becomes the same. As shown in FIG. 14, the shape changing portions 63 of the core sheets 11 to 16 are arranged along the axial direction. Further, as shown in FIG. 13, each shape changing portion 63 has a wave-like shape formed by combining a plurality of (a pair in the second embodiment) arcuate recesses and projections. A distal end 63a of a projection projecting out toward the radially outer side of the wave-like shape in the shape changing portion 63 radially faces the central position in the circumferential direction of a tooth 22.

The stator core 7 is fixed to the inner circumferential surface of the tubular housing 3 through press-fitting or thermal fitting after winding the segment winding 31 around the teeth 22. Then, the rotor 42 is arranged on the inner circumference of the stator 6 to manufacture the brushless motor 1.

The operation of the brushless motor 1 of the second embodiment will now be described.

When the drive current is supplied from the power supply circuit in the circuit accommodation box 5 to the segment winding 31, the stator 6 generates a rotating magnetic field to rotate the rotor 42 in a forward direction or a reverse direction. The rotor 42 is then rotated and driven while the magnetic flux is exchanged between the teeth 22 and the rotor 42. In the second embodiment, the cogging torque having the characteristic X shown in FIG. 9 is also generated by changes in the flow of the magnetic flux that occurs when each magnetic pole (permanent magnet 49, which is the magnet magnetic pole, and the salient pole 79, which is the pseudo-magnetic pole) traverses the vicinity of the distal end (rotor opposing portion 22b) of a tooth 22.

The second embodiment has the following advantages in addition to the advantages (1) to (8) of the first embodiment.

(9) The stator core is generally pressed against and fixed to the inner circumferential surface of the tubular case through press-fitting or thermal fitting. When the electromagnetic steel plate forming the stator core is receives load from the outer side and stress is generated, the magnetic properties of the stator core may degrade and the iron loss in the stator core may increase. The increase in the iron loss in the stator core lowers the motor efficiency.

In the second embodiment, the core sheets 11 to 16 include the plurality of shape changing portions 63 arranged at equal intervals along the circumferential direction of the core sheets 11 to 16. Each of the plurality of shape changing portions 63 is formed to reduce the contact area of the core sheets 11 to 16 and the inner circumferential surface of the tubular housing 3. Thus, when fixing the stator core 7 to the inner circumferential surface of the case 2 (tubular housing 3), the load from the tubular housing 3 acts only on a part of the stator core 7. The stress generated in the stator core 7 is thus reduced as a whole. This suppresses degradation of the magnetic properties of the core sheets 11 to 16 made from an electromagnetic steel plate. Therefore, in the inner rotor type brushless motor 1, iron loss is less likely to increase even if the stator core 7 is pressed against and fixed to the inner circumferential surface of the case 2, and a decrease in the motor efficiency is suppressed.

(10) The shape changing portions 63 are formed at an angular interval of a common factor of the angle (j×k) at which the core sheets 11 to 16 are rotated and 360°, and the changing portions 63 of the different core sheets 11 to 16 are arranged in the axial direction on the stacked core sheets 11 to 16. Therefore, the circumferential position of the load from the case 2 acting on the core sheets 11 to 16 becomes the same in each core sheet 11 to 16 so that the load evenly acts on each core sheet 11 to 16. Variations in air gaps between the distal ends of the teeth 22 and the rotor 42 is suppressed among the axially stacked core sheets 11 to 16, and for example, degradation in the cogging torque is reduced. Further, the relative position in the circumferential direction of each shape changing portion 63 and the corresponding tooth 22 becomes the same in each of the shape changing portions 63. Thus, when stacking the core sheets 11 to 16, the core sheets are easily rotated by a predetermined angle (30° in the present embodiment) in the circumferential direction using the shape changing portion 63 as a reference. A positioning portion for positioning in the circumferential direction does not need to be separately formed on the core sheets 11 to 16, and the shape of the core sheets 11 to 16 is suppressed from becoming complex.

(11) The shape changing portion 63 has a wave-like shape. Thus, the shape changing portion 63 is in point contact with the inner circumferential surface of the case 2. This further reduces the stress generated in the stator core 7 as a whole.

(12) The distal end 63a of the projection projecting toward the radially outer side of the wave-like shape in the shape changing portion 63 is formed at a position radially facing the central position in the circumferential direction of the tooth 22, which is the position where the rigidity is relatively high. Thus, compared to when the distal end 63a faces other positions of the stator core 7, deformation of the stator core 7 is suppressed by pressing the stator core 7 against the inner circumferential surface of the case 2. This reduces deformation of the stator core 7, and the stress generated in the stator core 7 is further reduced as a whole.

The first and second embodiments may be modified as described below.

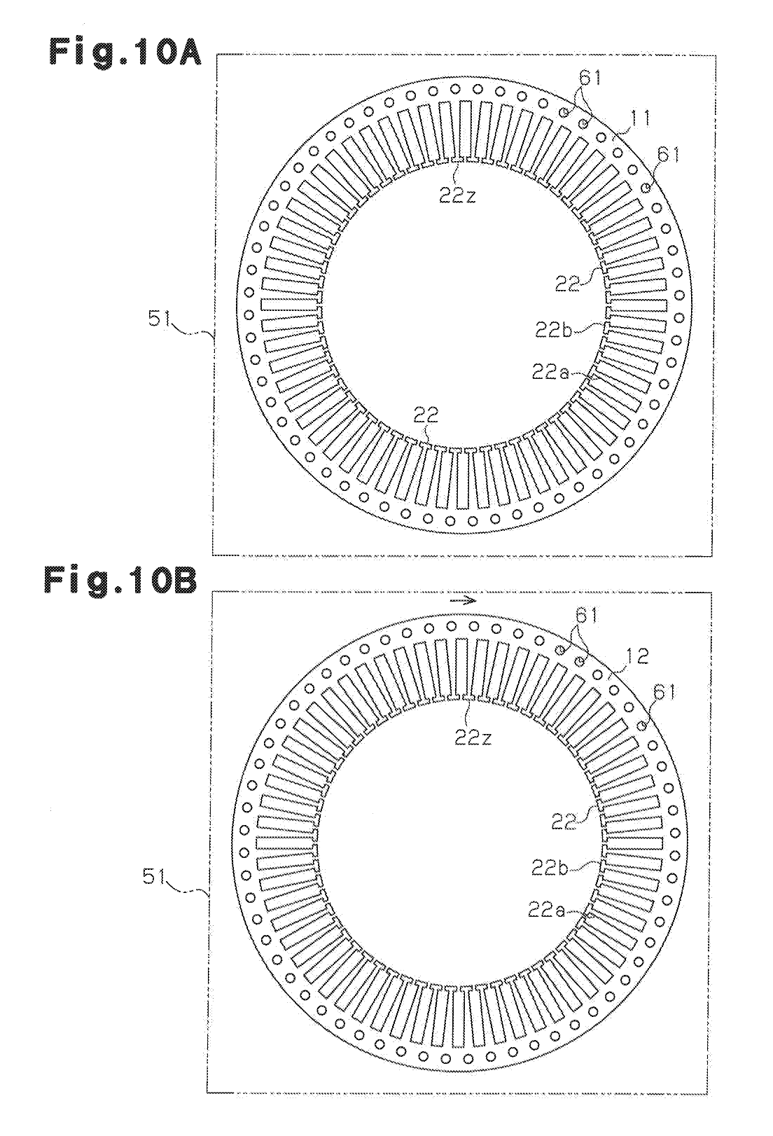

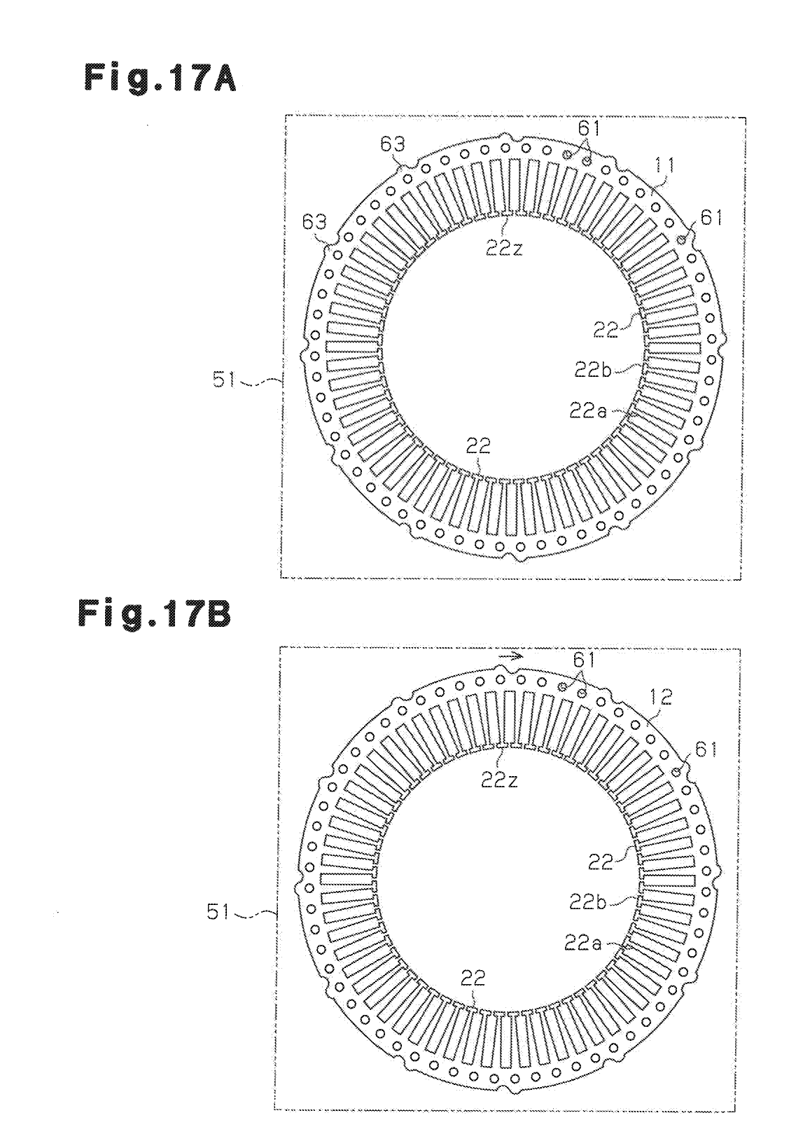

In the first and second embodiments, “5”, which is one of the solutions of j is used and “6°” is used as k, which is the angular interval of the slots S. The core sheets 11 to 16 punched out with the same punch die (not illustrated) are stacked while being rotated along the circumferential direction by “30°”, which is the angle of the product of “5” and “6°”, to form the stator core 7. Instead, other values of the solutions of j may be used. In other words, since the solutions of j in the first and second embodiments are 1, 5, 7, 11, 13, and so on, “1”, for example, may be used, as shown in FIGS. 10A, 10B and FIGS. 17A and 17B. The core sheets 11 to 16 may be stacked while rotating in the circumferential direction by “6°” that is the angle of the product of “1” and k (“6°” in the first and second embodiments), which is the angular interval of the slots S, to form the stator core 7.

Specifically, as shown in FIG. 10A and FIG. 17A, the core sheet 11 punched out (from the plate material) with the punch die (not shown) is first arranged on the stacking device 51 for performing the rotation stacking step. In this case, among the sixty teeth 22, the tooth 22z punched out at a specific portion of the punch die is arranged at a specific position (position immediately above in FIG. 10A and FIG. 17A) of the stacking device 51.

As shown in FIGS. 10B and 17B, the core sheet 12 punched out with the same punch die as that used to punch out the core sheet 11 is then arranged on the stacking device 51. The core sheet 12 is arranged on the core sheet 11 arranged in the previous process. In this case, among the sixty teeth 22, the tooth 22z punched out at a specific portion of the punch die is arranged at a position rotated by 6° in the circumferential direction (clockwise direction as viewed in the drawing) from the specific position (position immediately above in FIG. 10B) of the stacking device 51.

The core sheet 13 punched out with the same punch die as that used to punch out the core sheets 11 and 12 is then arranged on the stacking device 51 (not shown). The core sheet 13 is arranged on the core sheet 12 arranged in the previous process. In this case, among the sixty teeth 22, the tooth 22z punched out at a specific portion of the punch die is arranged at a position rotated by 6° from the core sheet 12 arranged in the previous process, that is, 12° in the circumferential direction (clockwise direction in the figure) from the specific position (position immediately above in FIG. 10A and FIG. 17A) of the stacking device 51.

The core sheet 14 punched out with the same punch die as that used to punch out the core sheets 11, 12, and 13 is then arranged on the stacking device 51 (not shown). The core sheet 14 is arranged on the core sheet 13 arranged in the previous process. In this case, among the sixty teeth 22, the tooth 22z punched out at a specific portion of the punch die is arranged at a position rotated by 6° from the core sheet 13 arranged in the previous process, that is, 18° in the circumferential direction (clockwise direction as viewed in the drawing) from the specific position (position immediately above in FIG. 10A and FIG. 17A) of the stacking device 51.

This may be repeated in the same manner to form the stator core 7.

Further, in this case, an m number of fixing portions (press-fitting recesses 61 and press-fitting projections 62) are formed, that is, for every 6°.

In this structure, the m number of fixing portions (press-fitting recesses 61 and press-fitting projections 62), which is the same number as the slots S (teeth 22), are formed in the annular portion 21 of the core sheets 11 to 16. The fixing portions are arranged at equal angular intervals along the circumferential direction of the stator. Thus, the positions of the fixing portions relative to the teeth 22 are all the same, and the degradation of the cogging torque characteristic by the fixing portion can be prevented.

In the second embodiment, “1” may be used for the solution of j, and the core sheets 11 to 16 may be stacked while rotated in the circumferential direction by “6°” to form the stator core 7 (see FIGS. 17A and 17B) like the other example of the first embodiment.

In the first and second embodiments, “7”, “11”, “13, and the like may be used as the solution of j, and the core sheets 11 to 16 may be stacked while rotated in the circumferential direction by “42°”, “66°”, or “78°” to form the stator core 7.

In the first and second embodiments, the value 6 is obtained by dividing the least common multiple of (n×k) and 360 by (n×k), and 24 is used as the value of p that is the multiple of value 6. In other words, only twenty four core sheets 11 to 16 are staked. However, the number of stacked sheets may be changed. In this case, the number of stacked sheets is preferably a multiple of 6 such as 18, 30, or the like. If the number of stacked sheets is the multiple of 6, an advantage similar to advantage (2) of the first embodiment can be obtained. Furthermore, the number of stacked sheets may be a number other than a multiple of 6 such as 20, 40 and the like.

In the first and second embodiments, the fixing portions (press-fitting recesses 61 and press-fitting projections 62) are formed at intervals of 30° that is the angular interval of the greatest common factor of 30°, which is the angle at which the core sheets 11 to 16 are rotated in the rotation stacking step, and 360°. The interval of the fixing portions may be changed as long as it is the angular interval of the common factor of 30°, which is the angle at which the core sheets 11 to 16 are rotated, and 360°. For example, the fixing portion (press-fitting recess 61 and press-fitting projection 62) may be formed at an interval of 15° or may be formed at an interval of 10°.

In the first and second embodiments, the fixing portions (press-fitting recesses 61 and press-fitting projections 62) are formed at positions corresponding to the central positions in the circumferential direction of the teeth 22, but are not limited in such a manner. For example, the fixing portions may be formed at positions shifted in the circumferential direction from positions corresponding to the central positions in the circumferential direction of the teeth 22.

In the first and second embodiments, the stator core 7 is held by the case 2 when the annular portion 21 is pressed against the inner circumferential surface of the case 2 (specifically, tubular housing 3). However, there is no such limitation. For example, the annular portion 21 does not have to be pressed against the case 2. Further, in the first and second embodiments, the present invention is embodied in the inner rotor type brushless motor 1. However, there is no such limitation. The present invention may be embodied in a brushless motor including an outer rotor with an annular portion and teeth extending radially outward from the annular portion. When applying the second embodiment to an outer rotor type brushless motor, the shape changing portion is formed on the inner circumferential surface of the stator core, and the stator core is fixed to the outer circumferential surface of the fixing member.

The winding of the stator 6 of the first and second embodiments is the segment winding 31. However, there is no such limitation. For example, the winding may be a conducting wire simply wound around the tooth.

In the first and second embodiments, the tooth 22 includes the width reducing portion 22a, which is the portion wound with the wiring (segment wiring 31). The width reducing portion 22a has a circumferential width that becomes narrower toward the rotor 42. However, there is no such limitation. For example, the portion of a tooth around which the winding is wound may include a constant width regardless of the distance from the rotor.

In the first embodiment, the direction in which the first permanent magnet MG1, the third permanent magnet MG3, and the fifth permanent magnet MG5 are arranged toward differs from the direction in which the second permanent magnet MG2 and the fourth permanent magnet MG4 are arranged toward. However, there is no such limitation. For example, the permanent magnets may all be arranged toward the same direction. Further, in the first embodiment, the positioning member 48 is fixed to the rotor core 46. However, there is no such limitation. For example, a jig corresponding to the positioning member 48 may be arranged in the rotor 46 only during manufacturing to fix the first to fifth permanent magnets MG1 to MG5, and the jig may be removed after the first to fifth permanent magnets MG1 to MG5 are fixed.

In the first and second embodiments, the core sheets 11 to 16 are stacked while rotated in the circumferential direction one by one at a time to form the stator core 7. However, there is no such limitation. For example, multiple groups of a predetermined number of (e.g., four) stacked core sheets punched out with the same punch die may be formed, and the core sheet groups may be stacked while being rotated in the circumferential direction to form the stator core.

In the first and second embodiments, the rotor 42 is a rotor having a consequent pole type structure. However, there is no such limitation. For example, a rotor in which a permanent magnet is arranged for every magnetic pole may be used.

In the first and second embodiments, the stator core 7 (annular portion 21) is pressed against the inner circumferential surface of the case 2 (specifically, tubular housing 3). However, there is no such limitation, and the stator core 7 may be thermally fitted into the inner circumferential surface of the case 2.

In the first and second embodiments, the tubular housing 3 is tubular and has a closed end. Instead, for example, a disk-shaped rear end plate discrete from the tubular housing 3 may be used as the portion corresponding to the bottom portion.

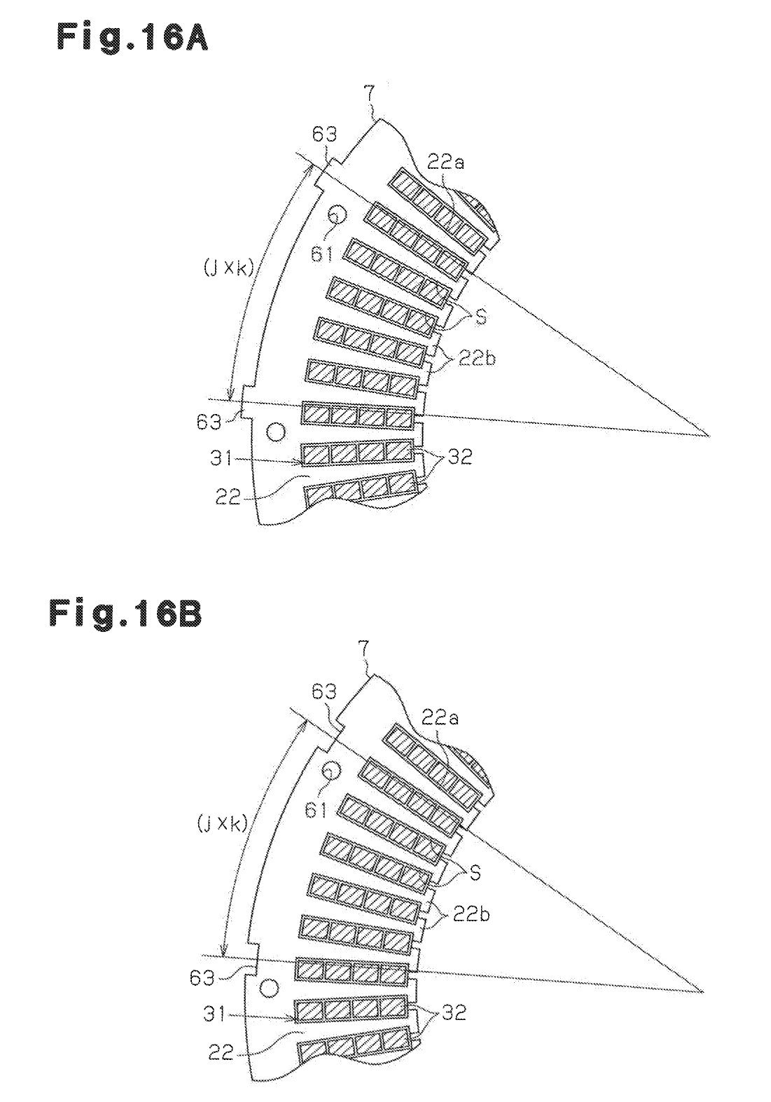

In the second embodiment, each shape changing portion 63 has a wave-like shape including a pair of a recess and a projection. However, there is no such limitation. For example, the shape changing portion 63 may be formed to have the shape of a substantially rectangular projection as shown in FIG. 16A or a substantially rectangular recess as shown in FIG. 16B. The shape of the shape changing portion 63 may be changed as long as the contact area of the core sheets 11 to 16 (stator core 7) and the inner circumferential surface of the case 2 can be reduced.

In the second embodiment, the shape changing portion 63 may be formed such that the distal end 63a of the shape changing portion 63 radially faces a position other than the central position in the circumferential direction of a tooth 22.

In the second embodiment, the core sheets 11 to 16 are stacked while shifting the core sheets 11 to 16 in the circumferential direction relative to each other by an angle, which is the product of one of the solutions of j and k, which is the angular interval of the slots S, to form the stator core 7. However, there is no such limitation. A plurality of core sheets may be stacked while being rotated in the circumferential direction to form the stator core 7 as described in the first and second embodiments in the stator having the so-called skew structure including the distal end of the tooth 22 inclined relative to the axial direction of the stator when the stator is viewed from the radial direction.

1. A brushless motor comprising:
a stator including a stator core having a plurality of teeth, which extend in a radial direction, and a winding, wherein a slot is formed between adjacent ones of the teeth, the stator includes an m number of the slots spaced apart from one another by a slot angular interval k in a circumferential direction, and the winding is arranged in the slot and wound around the teeth; and
a rotor including an n number of magnetic poles, wherein
the stator core includes a plurality of core sheets formed by punching a plate material with the same punch die,
the stator core includes the core sheets, which are stacked under a situation in which circumferential positions are shifted from one another by a first angle, or a plurality of core sheet groups, which are stacked under a situation in which circumferential positions are shifted from one another by the first angle and with each core sheet group including the core sheets having circumferential positions that are the same, wherein
the first angle is a product of one of a plurality of values of j and the slot angular interval k,
the plurality of values of j are values that satisfy (i×n)<(least common multiple of n and m) but do not satisfy (i×n×j×(360/m))=(360×N),
where i, j, and N are natural numbers.

2. The brushless motor according to claim 1, wherein
the stator core includes a p number of the core sheets or a p number of the core sheet groups, and
the value of p is a multiple of a value obtained by dividing a least common multiple of (n×k) and 360 by (n×k).

3. The brushless motor according to claim 1, wherein
each of the core sheets includes an annular portion that connects radial ends of the teeth,
the annular portion includes a plurality of fixing portions that fix the stacked core sheets to one another,
a number of the fixing portions is less than the m number, and
the fixing portions are arranged at a predetermined angular interval along the circumferential direction, and the value of the predetermined angular interval is a common factor of the first angle and 360°.

4. The brushless motor according to claim 3, wherein the plurality of fixing portions are arranged at positions respectively corresponding to central positions of the teeth in the circumferential direction.

5. The brushless motor according to claim 1, wherein
each of the core sheets includes an annular portion that connects radial ends of the teeth,
the annular portion includes an m number of fixing portions that fix the stacked core sheets to one another, and
the fixing portions are arranged at equal angular intervals along the circumferential direction.

6. The brushless motor according to claim 1, further comprising
a case that accommodates the stator and the rotor, wherein
each of the core sheets includes an annular portion that connects radial ends of the teeth; and
the stator core is held by the case by pressing the annular portion against an inner circumferential surface of the case.

7. The brushless motor according to claim 1, wherein
the winding is a segment winding including a plurality of segment conductors that are electrically connected to one another, and
the plurality of segment conductors are arranged along the radial direction in each of the slots.

8. The brushless motor according to claim 1, wherein each of the teeth includes a width reducing portion around which the winding is wound, and the width reducing portion has a width in the circumferential direction that narrows toward the rotor.

9. The brushless motor according to claims 1, wherein
the rotor includes a rotor core, a plurality of permanent magnets fixed to the rotor core, and pseudo-magnetic poles formed by portions of the rotor core located between adjacent ones of the permanent magnets;
the permanent magnets and the pseudo-magnetic poles are alternately arranged along the circumferential direction;
the rotor core includes a plurality of setting portions having a larger size than the permanent magnets to accommodate the permanent magnets; and
the permanent magnets are divided into two groups, each of a plurality of permanent magnets included in a first group is fixed in the corresponding one of the setting portions at a position arranged toward the pseudo-magnetic poles in a forward rotation direction, and each of a plurality of permanent magnets included in a second group is fixed to the corresponding one of the setting portions at a position arranged toward the pseudo-magnetic poles in a reverse rotation direction.

10. The brushless motor according to claim 9, wherein
each of the setting portions includes a lock portion that locks the permanent magnets in the circumferential direction; and
each of the permanent magnets included in the first group is fixed in the setting portions at a position arranged toward the pseudo-magnetic poles in the forward rotation direction by contacting with the lock portion in the forward rotation direction, and each of the permanent magnets included in the second group is fixed in the setting portions at a position arranged toward the pseudo-magnetic poles in the reverse rotation direction by contacting with the lock portion in the reverse rotation direction.

11. The brushless motor according to claim 1, further comprising
a tubular fixing member that fixes the stator, wherein
the rotor is arranged to radially face the stator,
the stator core is pressed against a circumferential surface of the fixing member and thereby held by the fixing member;
each of the plurality of core sheets includes a plurality of shape changing portions spaced apart from one another by an interval along the circumferential direction of the core sheets; and
the shape changing portions have a shape that reduces a contact area of each of the core sheets and the circumferential surface of the fixing member.

12. The brushless motor according to claim 11, wherein the plurality of shape changing portions are arranged at an angular interval of a common factor of the first angle and 360°.

13. The brushless motor according to claim 11, wherein
the stator core includes a p number of core sheets to 16) or a p number of core sheet groups, and
the value of p is a multiple of a value obtained by dividing a least common multiple of (n×k) and 360 by (n×k).

14. The brushless motor according to claim 11, wherein the shape changing portions are arranged so that the shape changing portions and the corresponding teeth have the same positional relationship.

15. The brushless motor according to claim 11, wherein each of the shape changing portions has a wave-like shape.

16. The brushless motor according to claim 11, wherein the shape changing portions include projections projecting toward a radially outer side from an outer circumferential surface of each of the core sheets, and the projections include distal ends corresponding to central positions of the teeth in the circumferential direction.

17. The brushless motor according to claim 11, wherein
each of the core sheets includes an annular portion that connects radial ends of the teeth,
the annular portion includes a plurality of fixing portions that fix the stacked core sheets,
the number of the fixing portions is less than m, and
the fixing portions are arranged at a predetermined angular interval along the circumferential direction, and a value of the predetermined angular interval is a common factor of the first angle and 360°.

18. The brushless motor according to claim 17, wherein the fixing portions are arranged at positions respectively corresponding to central positions of the teeth in the circumferential direction.

19. The brushless motor according to claim 11, wherein
each of the core sheets includes an annular portion that connects radial ends of the teeth;
the annular portion includes an m number of fixing portions that fix the stacked core sheets; and
the fixing portions are arranged at equal angular intervals along the circumferential direction.

20. The brushless motor according to claim 11, wherein
the fixing member is a tubular case having an inner circumferential surface,
each of the core sheets includes an annular portion that connects radial ends of the plurality of teeth, and
the stator core is held by the case by pressing the annular portion against an inner circumferential surface of the case.

21. The brushless motor according to claim 11, wherein
the winding is a segment winding including a plurality of electrically connected segment conductors, and
the segment conductors are arranged along the radial direction in each of the slots.

22. The brushless motor according to claim 11, wherein each of the teeth includes a width reducing portion around which the winding is wound, and the width reducing portion has a width in the circumferential direction that narrows toward the rotor.

23. The brushless motor according to claim 11, wherein
the rotor includes a rotor core, a plurality of permanent magnets fixed to the rotor core, and pseudo-magnetic poles formed by portions of the rotor core located between adjacent ones of the permanent magnets;
the permanent magnets and the pseudo-magnetic poles are alternately arranged along the circumferential direction;
the rotor core includes a plurality of setting portions having a larger size than the permanent magnets to accommodate the permanent magnets; and
the permanent magnets are divided into two groups, each of a plurality of permanent magnets included in a first group is fixed in the corresponding setting portion at a position arranged toward the pseudo-magnetic pole in a forward rotation direction, and each of the permanent magnets included in a second group is fixed in the corresponding setting portion at a position closer to the pseudo-magnetic pole in a reverse rotation direction.

24. The brushless motor according to claim 23, wherein
each of the setting portions has a lock portion that locks the permanent magnet in the circumferential direction; and
each of the permanent magnets included in the first group is fixed in the setting portion at a position arranged toward the pseudo-magnetic pole in the forward rotation direction by contacting with the lock portion in the forward rotation direction, and each of the plurality of permanent magnets included in the second group is fixed in the setting portion at a position arranged toward the pseudo-magnetic poles in the reverse rotation direction by contacting with the lock portion in the reverse rotation direction.

25. A method for manufacturing a brushless motor including
a stator including a stator core having a plurality of teeth, which extend in a radial direction, and a winding, wherein a slot is formed between adjacent ones of the teeth, the stator includes an m number of slots spaced apart by a slot angular interval k in a circumferential direction, and the winding is arranged in the slot and wound around the teeth; and
a rotor including an n number of magnetic poles,
the method comprising:
punching a plate material with the same punch die to form a plurality of core sheets; and
forming the stator core by stacking the core sheets, under a situation in which circumferential positions are shifted from one another by a first angle, or stacking a plurality of core sheet groups, under a situation in which circumferential positions are shifted from one another by the first angle and with each core sheet group including the core sheets having circumferential positions that are the same, wherein
the first angle is a product of one of a plurality of values of j and the slot angular interval k,
the plurality of values of j are values that satisfy (i×n)<(least common multiple of n and m) but do not satisfy (i×n×j×(360/m))=(360×N),
where i, j, and N are natural numbers.

26. The method for manufacturing the brushless motor according to claim 25, further comprising performing press-fitting or thermal fitting of the stator core into an inner circumferential surface of a tubular housing.
